(19) United States
(12) Patent Application Publication
(10) Pub. No.: US 2004/0083359 A1
(43) Pub. Date: Apr. 29, 2004

(54) Delegation by electronic certificate

(75) Inventors: Sylvie Camus, Palaiseau (FR); Laurent Frisch, Paris (FR); Dimitri Mouton, Paris (FR)

Correspondence Address: LOWE HAUPTMAN GILMAN AND BERNER, LLP, 1700 DIAGONAL ROAD, SUITE 300 /310, ALEXANDRIA, VA, 22314, US

(73) Assignee: FRANCE TELECOM

(21) Appl. No.: 10/686,740

(22) Filed: Oct. 17, 2003

(30) Foreign Application Priority Data
Oct. 22, 2002 (FR) 02-13179

(51) Int. Cl. H04L 9/00

(52) U.S. Cl. 713/156

(57) ABSTRACT

To avoid recourse to a certification authority and to keep a trace of delegation to a delegate by a titleholder, a terminal of the titleholder draws up a second electronic certificate different from the normal certificate of the delegate. The second certificate includes at least a delegation attribute and a signature of the data in the second certificate by means of a private key of the titleholder. The titleholder behaves like a certification authority in respect of the second certificate, which is used for cryptographic actions by the delegate in the name of the titleholder.

### BACKGROUND OF THE INVENTION

1—Field of the Invention

The present invention relates to delegation of cryptographic means by electronic certificates.

2—Description of the Prior Art

Given a cryptographic key comprising a public key and a private key, it is fundamentally an electronic certificate issued by a certification authority that makes it possible to have confidence in the public key. This certificate includes in particular the public key to be certified, the identity of the holder of the public key, a certificate validity period, a list of attributes corresponding to rights of use of the key and called as key usage attributes, supporting parameters such as a message signature key or a secure web server key, for example, and a cryptographic signature of the data contained in the certificate by a public key of the certification authority issuing the certificate.

Confidence in the public key associated with an identity relies on the validity of the certificate C, which depends in particular on the validity of a chain of confidence of the certificate. The chain of confidence of the certificate C is a finite series of N certificates C1, C2, . . . , Cn, Cn+1, . . . , CN issued by respective certification authorities AC2, ACn, . . . , ACn+1, . . . , ACN, the first certificate C1 being the certificate C to be verified. The finite series of the chain of confidence ends with a certificate CN explicitly designated a confidence certificate. A certificate Cn is certified by the certification authority ACn+1, which issues a certificate Cn+1. As a general rule, the confidence certificate CN is a root of the chain of confidence and constitutes a certificate auto-signed by a certification authority well known to the community of other certification authorities liable to refer thereto. A chain of confidence is validated by the individual validity of each of the certificates Cn and by the validity of the chain at the level of each certification authority ACn+1, to ensure that the certification authority ACn+1 has indeed signed the certificate Cn into the certificate Cn+1.

The key usage attributes of a certification authority included in the certificate issued by this authority specify in particular the authorized depth of certification. A certification authority being able to certify only end users or servers has at a minimum authorized certification depth, for example equal to zero. An end user has an attribute indicating that it does not have the right to issue certificates. If this attribute is not referred to, it is assumed by default that the user does not have the right to issue certificates; by convention, the authorized certification depth has the value −1.

An electronic signature guarantees the authenticity of a document, i.e. securely authenticates one or more signatories having executed the signature, and guarantees that the document has not been tampered with. The electronic signature is often used to guarantee non-repudiation of the document, i.e. to guard against denial of the document by its author.

Another technique is the multi-agent technique whereby the electronic signature is a group signature that ensures the anonymity of the signatory belonging to the group, who signs in the name of the group.

The known formats of electronic signature provide no means for including an indication of signature delegation.

At present, few electronic signature systems provide for signature delegation. In particular, none of these systems provides for delegation of certified cryptographic keys.

Where signature delegation does exist in an electronic signature system, it generally relates to delegation of rights, with means for managing approvals effected internally by the system, in the most favorable cases via a more general directory.

For example, a group of titleholders who have the right to take decisions within the system can be defined in a workflow. To alleviate titleholder absences, one or more delegates can be attached to each titleholder.

A titleholder can decide, for example at the time of an action in the workflow such as a declaration of paid leave, to assign some or all of the titleholder's authorizations to the delegate for a predetermined delegation period in order not to cause discontinuity in the workflow. Decisions in the workflow taken by the delegate are taken in the name of the titleholder.

All trace of the delegation is usually lost when the delegation period ends. In the most favorable situations, the delegation can be uncovered from workflow logs, but this requires a complex and costly search operation, especially if the search is conducted a long time afterwards.

In the case of workflows including an electronic signature, in which case the object of the decision is the electronic signing of a document, existing electronic signature formats do not provide a “signed on behalf of” field identifying the titleholder in whose name the signature has been effected by the delegate. The signed document, once it has left the workflow, for example for processing by a third party or archival storage, includes only the signature of the delegate, with no trace of the titleholder in whose name the delegate effected the signature.

Because the delegation of power is not included in the electronic signature, it cannot be uncovered once the signed document has left its delegation context.

Now, the electronic signature must be durable, and the elements for determining the conditions under which the signature was executed must likewise remain durable, for example by adding the written indication “per pro” in the case of a manuscript signature.

Furthermore, delegation often necessitates, for the titleholder and/or the delegate, intervention by the management means for authorizing delegation.

### OBJECT OF THE INVENTION

A main object of the present invention is to enable the delegate to use his own key to effect cryptographic actions under the direct authority of the titleholder, without recourse to a certification authority, and to introduce a trace of the delegation into the certificate used by the delegate in the name of the titleholder.

### SUMMARY OF THE INVENTION

To reach this object, an electronic certification method for delegating actions of a titleholder having an electronic certificate stored in a titleholder terminal to a delegate having a first electronic certificate stored in a delegate terminal, the certificate of the titleholder and the first certificate of the delegate further including respective public keys and certificate signatures of respective certification authorities, is characterized in that it comprises the following steps after solicitation of delegation to the delegate by the titleholder:

in the delegate terminal, drawing up a recertification request and transmitting the recertification request to the titleholder terminal,

in the titleholder terminal, drawing up a second electronic delegate certificate in response to the recertification request and transmitting the second certificate to the delegate terminal, the second certificate including data such as the public key of the titleholder, the public key of the delegate and a delegation attribute, and a signature of the data with a private key of the titleholder, and

in the delegate terminal, validating the signature in the second delegate certificate transmitted in order for the delegate terminal to use the validated second certificate for any action delegated by the titleholder to the delegate.

Thus the invention inserts the titleholder into an authority of certification for the delegate, since the data contained in the second certificate, and in particular the delegate public key, is signed by the titleholder.

The delegation attribute represents a trace of the delegation. Preferably this trace is complemented or replaced by an attribute representing an authorization of the titleholder to delegate, included in the certificate of the titleholder, which can in turn be included in the data of the second delegate certificate.

### BRIEF DESCRIPTION OF THE DRAWINGS

Other features and advantages of the present invention will become more clearly apparent on reading the following description of plural preferred embodiments of the invention, which description is given with reference to the corresponding appended drawings, in which:

FIG. 1 is a schematic block-diagram of a telecommunication system including a titleholder terminal and a delegate terminal and various servers for implementing the electronic certification method according to the invention; and

FIG. 2 shows an algorithm of main steps of the electronic certification method according to the invention.

### DETAILED DESCRIPTION OF THE PREFERRED EMBODIMENTS

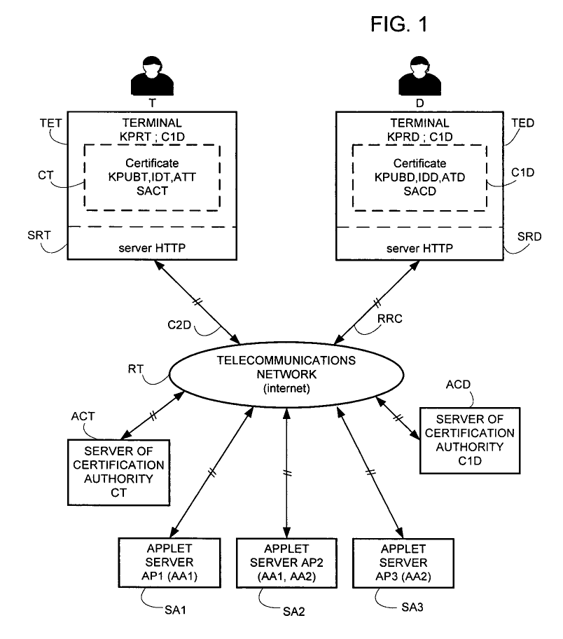

Referring to FIG. 1, two terminals TET and TED are respectively assigned to a titleholder user T and a delegate user D. The two terminals are connected by a telecommunications network RT. For example, the terminals TET and TED are personal computers and the network RT is an Ethernet local area network (LAN), a wide area network (WAN), or comprises access networks connected by the Internet. At least one of the terminals TET and TED can be a portable electronic device such as a personal digital assistant (PDA) or a portable computer. In another example, at least one of the terminals TET and TED is a mobile radio telephone and the network RT further comprises the digital cellular radio telephone network of the mobile radio telephone.

Initially, each terminal TET, TED has stored in its memory an electronic certificate CT, C1D identifying the respective user T, D and containing in particular a public key KPUBT, KPUBD of the user T, D holding the certificate, the identity IDT, IDD including, for example, the name and forename of the user, a validity period, where applicable attributes ATT, ATD such as the identity of the electronic certification authority ACT, ACD that created the certificate, the public key of that authority, the name of the algorithm used to sign the certificate, etc. The certificate CT, C1D further comprises a cryptographic signature SACT, SACD of all of the preceding data contained in the certificate CT, C1D, established by the certification authority ACT, ACD that issued the certificate. As shown in FIG. 1, the certification authorities ACT and ACD are servers connected to the network RT and whose role is to sign certificates, to publish certificates in directories, and to draw up lists, known as blacklists, of certificates that have been revoked.

Each terminal TET, TED further contains a private key KPRT, KPRD corresponding to the public key KPUBT, KPUBD for signing messages to be transmitted by means of a predetermined asymmetrical algorithm AA.

It is initially assumed that the titleholder T is authorized to delegate actions to the delegate D by the certification authority ACT. The titleholder T knows the delegate D and consequently the terminal TET of the titleholder T has already stored in its memory the first certificate C1D of the delegate D.

Authorization for delegation of the titleholder T can take the form of a key usage attribute ATT issued by the certification authority ACT with an authorized certification depth equal to 0 and included in the titleholder certificate CT; the authority ACT then issues a certification policy compatible with this type of key usage attribute. The titleholder T advantageously becomes a certification authority in its own right for purposes of delegation. As explained hereinafter, the delegation certificate that the titleholder terminal TET establishes does not necessitate more specific checking than the checking performed by other certification authorities at the time of validating a chain of confidence.

As an alternative to this, the titleholder certification authority ACT represents the right of the titleholder to delegate, both by a key usage attribute of the certification authority ACT with an authorized certification depth of 0 and by a specific delegation attribute.

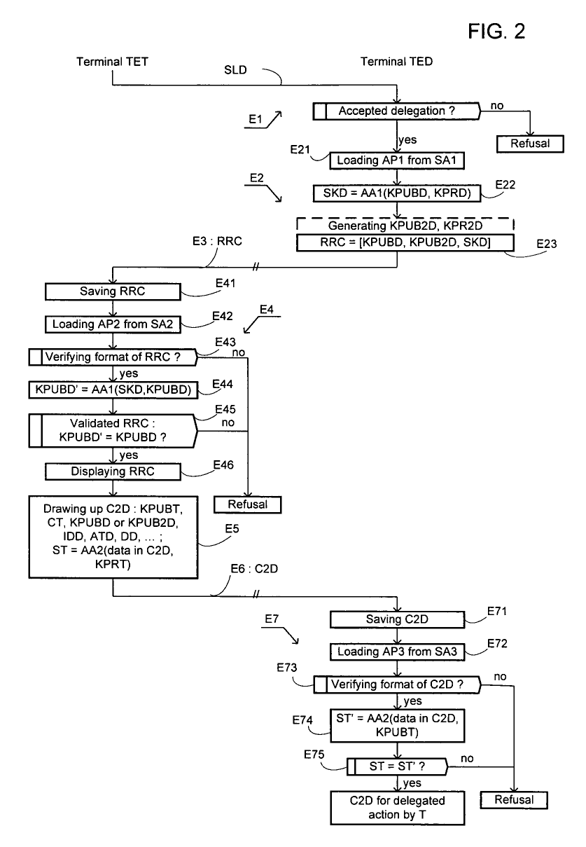

According to the invention, electronic certification for delegating actions of the titleholder T to the delegate D consists mainly of the steps E1 to E7 shown in FIG. 2.

In step E1, the user T submits a delegation solicitation SLD in respect of the delegate D, either directly at the time of a meeting between the users T and D, or by means of a message transmitted by the terminal TET to the terminal TED, for example in electronic mail form.

As a further alternative, a software server SRD, for example a hypertext transfer protocol (HTTP) web server, is implemented in the terminal TED. The server SRD is a program executing in the terminal TED in response to a delegation solicitation message SLD transmitted by the terminal TET. The server SRD then draws up a recertification request RRC, as described hereinafter, and transmits it to the terminal TET. As an alternative to this, the server SRD is an electronic mail client server that filters solicitation electronic messages SLD from authorized titleholders.

Prior to the delegation solicitation step, and regardless of the server SRD type, the latter can decide to authenticate the terminal TET either by signing the electronic mail solicitation message SLD or by authenticating in accordance with a predetermined secure sockets layer (SSL) security protocol for an HTTP server, or by an authentication process using an identifier and a password, etc. In practice, a server SRT implemented in the terminal TET preferably requests authentication of the server SRD, i.e. authentication of the delegate D by the titleholder T, or possibly mutual authentication of the servers SRD and SRT. The software server SRT is of the same type as the server SRD, for example the HTTP/SSL type.

If the titleholder T soliciting delegation is not authorized to delegate to the delegate D, or if the delegate refuses the solicited delegation, the solicitation SLD is rejected, for example by transmitting a predetermined refusal message from the terminal TED to the terminal TET.

In step E2, the terminal TED draws up a recertification request RRC. To this end, step E2 includes in particular substeps E21, E22 and E23.

In substep E21, the terminal TED communicates with an applet web server SA1 installed by the titleholder's certification authority ACT to recover a Java applet AP1 that enables the terminal TED's browser to draw up the request RRC. The applet AP1 can be loaded into the terminal TED before step E1 if the terminal TED has recently drawn up a recertification request. The applet AP1 includes in particular an asymmetrical algorithm AA1 to which the public key KPUBD, as data, and the private key KPRD are applied to determine an electronic signature SKD of the public key of the delegate D, in step E22. The terminal TED then draws up the recertification request RRC, introducing into it the public key KPUBD, the signature SKD thereof previously established, and where applicable the first certificate C1D enabling the titleholder T to verify confidence in the delegate D, in substep E23. The terminal TED transmits the request RRC drawn up in this way to the terminal TET via the network RT, in step E3.

As an alternative to this, the terminal TED transmits the recertification request RRC in the form of an electronic mail message to the terminal TET in step E3.

After the terminal TED has transmitted the recertification request RRC to the terminal TET via the telecommunications network RT, in step E3, the terminal TET saves the request RRC, for example on a hard disk or in a RAM memory thereof, in a substep E41 of a signature validation step E4 comprising substeps E42 to E46.

In substep E42, unless a Java applet AP2 for verifying the validity of the recertification request RRC received has already been installed once and for all in the terminal TET, the terminal TET communicates with a second applet server SA2 to recover the applet AP2. The applet server SA2 is also under the control of the certification authority ACT and can be combined with the first applet server SA1.

Then, in substeps E43 to E45, using the loaded applet AP2, the titleholder terminal TET verifies the format of the received recertification request RRC and validates the latter in relation to the signature SKD. The request RRC, i.e. the signature SKD, is validated by applying to the algorithm AA1 contained in the applet AP2 the signature SKD, as data, and the public key KPUBD extracted from the received request RRC, normally producing a public key KPUBD′ that is compared to the public key KPUBD extracted from the request RRC, in substep E45. If the result of the verification substep E43 or the validation substeps E44-E45 is erroneous, the titleholder T can decide to refuse and to stop the delegation in progress, or to solicit delegation again by transmitting a delegation solicitation SLD in step E1.

If the request RRC is validated, i.e. in this instance if the public key KPUBD is validated in substep E45, the terminal T displays the recertification request RRC in substep E46. For example, the terminal T displays in particular the certificate C1D, which is extracted from the request RRC if the request RRC contains it, or which is read in the memory of the terminal TET, for the titleholder T to confirm validation of the received request RRC and for continuation of electronic certification for delegation via the main step of drawing up the second delegate certificate in step E5. As an alternative to this, the titleholder is not involved in step E46, and the request RRC is validated entirely automatically in the terminal TET.

In step E5, and on the basis of the first certificate C1D, the titleholder terminal TET draws up a second electronic delegation certificate C2D that is substituted for the first certificate C1D by the delegate terminal TED when the delegate D will act in the name of and on behalf of the titleholder T.

The second delegate certificate C2D is drawn up by means of the second applet AP2 and includes in particular a public key KPUBT of the titleholder, the public key KPUBD of the delegate D, the delegate identity IDD, a delegate type delegation attribute ATD, or an indication “per pro” or “on behalf of”, preferably followed by the name of the titleholder T, a delegation duration DD fixed by the titleholder T, and other attributes that may be needed to be able to mandate the delegate D. All the above data contained in the certificate C2D is applied to an asymmetrical algorithm AA2 that is included in the loaded applet AP2 and whose key consists of the private key KPRT of the titleholder T corresponding to the public key KPUBT. The algorithm AA2 executed in substep E5 delivers a signature ST of the second certificate C2D.

Thus the titleholder T behaves as an electronic certification authority for the delegate D during the delegation duration DD. The certificate C2D is drawn up by means of a form displayed on the screen of the terminal TET for the user T to enter data such as the delegation duration DD, an identity of the titleholder, such as the name or a nickname of the titleholder in the delegation attribute ATD, etc.

As a simple alternative to the above, the second certificate C2D contains no particular option relating to attributes, and in particular does not contain the delegation attribute ATD, given that the titleholder T issuing the certificate is already in possession of a certificate authorizing delegation.

As a further alternative, a random generator in the delegate terminal TED generates a second public key KPUB2D and a second private key KPR2D that are dedicated to delegation and are therefore used to secure and exchange messages with the terminal TED only for actions delegated to the delegate D by the titleholder T. As shown in dashed line in step E23 in FIG. 2, the second public key KPUB2D is included in the recertification request RRC in step E3, and the titleholder terminal TET extracts from the saved recertification request the public key KPUB2D in order to introduce it into the second certificate C2D to be drawn up, in place of the normal public key KPUBD of the delegate D.

Then, in step E6, the applet AP2 in the terminal TET transmits the second certificate C2D to the delegate terminal TED via the server SRT, the network RT, and the server SRD, or in the form of an electronic mail message.

In the delegate terminal TED, step E7 for validating the second electronic certificate C2D comprises substeps E71 to E76.

In substep E71, the terminal TED saves the received certificate C2D on its hard disk or in its RAM memory, for example. Then, in substep E72, the terminal TED recovers from a third applet server SA3, which is under the governance of the certification authority ACT, a third applet AP3 for validating the received certificate C2D, unless the applet has already been loaded into the terminal TED. The server SA3 can be combined with at least the server SA1, to load an applet AP1 combined with the applet AP3 in step E21. In a further alternative the applet servers SA1, SA2 and SA3 are combined into a single server that contains the applets AP1, AP2 and AP3.

After verification of the format of the received certificate C2D in substep E73, the terminal TED initiates a validation of the certificate C2D by applying the data contained therein and the public key KPUBT also included in the applet AP3 to the asymmetrical algorithm AA2 identified in the certificate C2D and recovered in the applet AP3. The execution of the algorithm AA2 produces a signature ST′ that is compared to the signature ST extracted from the received certificate C2D in substep E75. If the verification or validation in substep E73 or E75 is not satisfactory, the delegate terminal TED refuses the second certificate C2D, for example, by transmitting a predetermined refusal message to the terminal TET. Otherwise, the terminal TED stores the validated certificate C2D in its memory throughout the delegation duration DD in order to use the second certificate C2D and in particular its private key KPRD or KPR2D for diverse cryptographic actions effected by the delegate D, in particular from the delegate terminal TED, in the name of and on behalf of the titleholder T.

Depending on the medium of the delegate composite key [KPUBD, KPRD], the second certificate C2D is integrated more or less automatically into the delegate terminal TED. If the delegate's composite key is a software key managed by a browser, by an electronic message recovery and transfer tool, or by an operating system, by a software server such as the server SRD previously cited, or by any other appropriate software implemented in the terminal TED, the certificate C2D is integrated by that software in the terminal TED in order to have the second certificate available in corresponding relationship to the existing delegate composite key for subsequent use in all delegated actions.

Another alternative, if the delegate composite key [KPUBD, KPRD], or more generally the delegate certificate ClD, is stored on a hardware storage medium removable from the delegate terminal TED, such as a smart card or a universal serial bus (USB) token, is for the management tool in that medium itself to request recertification of the existing public delegate key and to command storage of the second delegate certificate C2D in the removable medium in step E7. If a second key [KPUB2D, KPR2D] is generated in step E2, the management tool of the medium integrates the second certificate C2D. Placing the received second certificate C2D in the removable hardware medium is preferably automated, requiring no intervention of the delegate user D. However, as an alternative to this, the second certificate can be integrated semi-automatically, by prompting the delegate D via the display of the terminal TED to insert the removable hardware medium into the terminal TED in order to store the certificate C2D thereon. The removable storage medium enables the delegate to use any other terminal for delegated actions provided with a reader appropriate to the removable storage medium.

If the private key KPRD of the delegate D has been compromised, i.e. is known to at least one third party or has been tampered with, the delegate D revokes all certificates relying on the key, including the delegation certificate C2D. To revoke the certificate C2D, the terminal TED contacts a revocation server that is known to the delegate D and can be installed by the titleholder and linked to the server ACD of the delegate certification authority, or contacts the certification authority server ACT of the titleholder T directly or via a personal server dedicated to revocation of delegation.

A further alternative, when the delegation certificate C2D is drawn up in step E5, is for the terminal TE to include in the data of the second certificate C2D information relating to revocation of the certificate C2D, for example the address of a predetermined revocation server.

To facilitate establishing the chain of confidence from the delegation certificate C2D, the delegate terminal TED appends the titleholder certificate CT to the delegation certificate C2D for any action delegated by the titleholder T. In this variant, the certificate CT of the titleholder T is also included in the data of the second certificate C2D transmitted by the titleholder terminal TET to the delegate terminal TED in step E6 for the terminal TED to extract the titleholder certificate CT from the saved certificate C2D.

Starting from the titleholder certificate CT, the chain of confidence is established and verified in the same way as for any chain of confidence in the absence of delegation. The verification of the delegation chain of confidence, i.e. included with the delegation certification C2D, implies the verification of attributes, in particular by the certification authority ACT in the case of the titleholder certificate CT and by the terminal TET in the case of the delegation certificate C2D.

In a further variant still, the initial steps E2, E3 and E4 in particular, relating to the drawing up and transmission of the recertification request RRC and to the validation of the electronic signature SKD are eliminated to increase the speed of execution of the electronic certification in accordance with the invention. In this variant, the electronic certification starts before the step E5 of drawing up the certificate, by generating a private key KPRT of the titleholder T in the terminal TET for the terminal TET to establish in step E5 the signature ST of the data of the certificate C2D by means of the generated private key KPRT. The data such as the public key KPUBT of the titleholder and the public keys KPUBD, ATD, DD contained in the first delegate certificate C1D are stored beforehand in the memory of the terminal TET. The generated private key KPRT is then transmitted to the delegate terminal TED substantially in parallel with the electronic second delegate certificate C2D, in step E6; for example, the private key KPRT is encrypted in the terminal TET as a function of a password entered by the titleholder T, or transmitted via a channel, such as by oral transmission by telephone between the titleholder T and the delegate D, other than the transmission channel between the terminals TET and TED via the network RT.

What we claim is:

1. An electronic certification method for delegating actions of a titleholder having an electronic certificate stored in a titleholder terminal to a delegate having a first electronic certificate stored in a delegate terminal, said certificate of said titleholder and said first certificate of said delegate further including respective public keys and certificate signatures of respective certification authorities, said method comprising the following steps after solicitation of delegation to said delegate by said titleholder:
in said delegate terminal, drawing up a recertification request and transmitting said recertification request to said titleholder terminal,
in said titleholder terminal, drawing up a second electronic delegate certificate in response to said recertification request and transmitting said second certificate to said delegate terminal, said second certificate including data such as said public key of said titleholder, said public key of said delegate and a delegation attribute, and a signature of said data with a private key of said titleholder, and
in said delegate terminal, validating said signature in said second delegate certificate transmitted in order for said delegate terminal to use said second certificate for any action delegated by said titleholder to said delegate.

2. The method claimed in claim 1, wherein said data in said second delegate certificate includes a delegation duration.

3. The method claimed in claim 1, wherein said data in said second delegate certificate includes information relating to revocation of said second certificate.

4. The method claimed in claim 1, wherein said titleholder certificate is included in said data of said second delegate certificate.

5. The method claimed in claim 1, wherein an attribute representing authorization of said titleholder to delegate is included in said titleholder certificate.

6. The method claimed in claim 1, including determination of a signature of said public key of said delegate in said delegate terminal as a function of a private key of said delegate, said delegate public key and said signature being introduced into said recertification request, and validation of said signature extracted from the received recertification request as a function of said delegate public key by said titleholder terminal, before drawing up said second delegate certificate.

7. The method claimed in claim 1, including generation of second delegate public and private keys in said delegate terminal, said second public key being included in said recertification request and then introduced into said delegate second certificate by said titleholder terminal in place of said respective public key of said delegate.

8. The method claimed in claim 1, including generation of said private key of said titleholder in said titleholder terminal, in place of drawing up and transmitting said recertification request, in order to establish said signature of said data by means of said private key and transmit said private key of said titleholder substantially in parallel with said electronic second delegate certificate to said delegate terminal.

9. The method claimed in claim 1, wherein said second delegate certificate is stored on a storage medium removable from said delegate terminal.
